(19) United States
(12) Patent Application Publication
(10) Pub. No.: US 2014/0022813 A1
(43) Pub. Date: Jan. 23, 2014

(54) Transparent Emissive Window Element

(71) Applicant: Klazina Bernarda Bergsma, (US)

(72) Inventors: Marcellinus Petrus Carolus Michael Krijn, Eindhoven (NL); Jochen Renaat Van Gheluwe, Lommel (BE); Gabriel-Eugen Onac, Veldhoven (NL); Antonius Hendricus Maria Holtslag, Eindhoven (NL); Anthonie Hendrik Bergman, Nuenen (NL)

(73) Assignee: KONINKLIJKE PHILIPS ELECTRONICS ,N.V., Eindhoven (NL)

(21) Appl. No.: 13/511,785

(22) PCT Filed: Dec. 1, 2010
(86) PCT No.: PCT/IB2010/055519

§ 371 Date: Sep. 9, 2013

(30) Foreign Application Priority Data
Dec. 3, 2009 (EP) 09177884.5

(51) Int. Cl. F21V 8/00

(52) U.S. Cl. CPC G02B 6/0053
USPC 362/606; 362/235; 362/231

(57) ABSTRACT

The present invention discloses a transparent emissive window element (100, 700), i.e. a transparent window element capable of emitting light. According to a first aspect of the present invention, the window element (100) comprises a light guide (110) for guiding light emitted from at least one light source (150) by total internal reflection, a glass pane (120) arranged in proximity to the light guide and scattering structures (130) for coupling the light out of the light guide. The scattering structures (130) are sandwiched between the light guide (110) and the glass pane (120) such that spacing areas (140), at which optical contact between the light guide and the glass pane is prevented, are formed between the scattering structures. According to a second aspect of the present invention, the window element (700) comprises at least one light source (750), a glass pane (710) and refracting structures (740) arranged at a surface of the glass pane (710) such that light emitted from the light source is refracted by the refracting structures towards the glass pane and directed out of the window element (700).

### FIELD OF THE INVENTION

The present invention relates to a window element, and more particularly to a window element capable of emitting light, i.e. a luminous window element. The window element may be arranged in a door frame or a window frame and may be used in various types of buildings like office buildings, commercial buildings, hotels, hospitals and homes.

### BACKGROUND OF THE INVENTION

Luminous windows or transparent emissive windows are windows that either are transparent and appear as ordinary windows when turned off or are luminous, i.e. emit light, when turned on. These windows may for instance be used for general lighting or for displaying a sign or logo.

Generally, a luminous window comprises a transparent polymer material acting as a light guide, which may be lit by means of a light source. The light guide may comprise scattering elements for extracting the light out of the light guide and, for instance, direct it into a room. As such emissive windows are added to, integrated in or meant to replace existing windows into a building structure, they are exposed to external influences (i.e. the conditions of the surrounding environment). However, a polymer light guide freely exposed to its surroundings is usually vulnerable to scratching and/or contamination (e.g. dust, fingerprints), which may result in a strong and undesired extraction of the light from the light guide at those scratched and/or contaminated locations. Further, polymer materials often have a large temperature expansion coefficient and a hygroscopic nature, which may result in deformation and warping of the light guide when exposed to temperature and moisture fluctuations. Further, polymer materials often have a low fire resistance, which makes the light guide a fire hazard when large surfaces are freely exposed. In order to circumvent these problems, the light guide is conventionally protected by one or more sheets of glass.

For example, International patent application WO2006/065049 discloses a luminous window or door comprising a light guide panel in which letters or patterns are engraved by means of micro depressions. A protective glass or protective film is attached to both sides of the light guide panel to protect the surface from damage or defect such as e.g. scratches.

Although the light guide panel is protected against external influences by the glass panes, the uniformity of the light emitted from such types of luminous windows (or doors) is still limited, with e.g. darker and lighter areas, which is rather unattractive for an observer.

### SUMMARY OF THE INVENTION

It is an object of the present invention to alleviate this problem, and to provide a window element providing an improved light uniformity.

According to a first aspect of the invention, this and other objects are achieved by means of a window element comprising a light guide for guiding light emitted from at least one light source by total internal reflection, a glass pane arranged in proximity to the light guide and scattering structures for coupling the light out of the light guide. The scattering structures are sandwiched between the light guide and the glass pane such that spacing areas (or regions), at which optical contact between the light guide and the glass pane is prevented, are formed between the scattering structures.

The present invention makes use of an understanding that light may leak out of the window element, i.e. leak out of the light guide and into the glass pane (or glass sheet), in an uncontrolled fashion if there is a direct optical contact between the light guide and the glass pane. The solution as defined in the first aspect of the present invention is based on the idea that the scattering structures themselves are used for preventing optical contact between the light guide and the glass pane. In other words, the scattering structures act as spacers (or together as a spacing layer) between the light guide and the glass pane, thereby preventing optical contact. Such a solution is advantageous in that it provides a more uniform light emission from the window element. It will be appreciated that the thickness of the scattering structures ensures that any optical contact between the light guide and the glass pane is prevented (or at least that the number of contact points between the light guide and the glass pane is reduced). The thickness may be selected such that, even though the window element is subject to deformations due to e.g. temperature and/or moisture, any optical contact between the light guide and the glass pane is prevented.

The present invention is advantageous in that a clearer and less distorted view through the window element is provided since unwanted light leakage from the light guide to the glass pane is prevented. The present invention is also advantageous in that a glass pane is used, thereby protecting the light guide from scratches and contamination which would otherwise occur when exposing the window element to external influences.

According to a second aspect of the present invention, the object of the present invention is achieved by means of a window element comprising at least one light source, a glass pane and refracting structures arranged at a surface of the glass pane such that light emitted from the light source is refracted by the refracting structures towards the glass pane and directed out of the window element.

Such a solution still makes use of the understanding that, in conventional window elements, light may leak out from the light guide into the glass pane (or glass sheet) in an uncontrolled fashion if there is a direct optical contact between the light guide and the glass pane. The solution as defined in the second aspect of the present invention is based on a configuration wherein no light guide is needed, thereby avoiding any optical contact of such a light guide with a glass pane. Instead, the window element according to the second aspect of the present invention comprises a light source emitting light towards refracting structures which direct the light towards a glass pane and out of the window element. Such a solution is advantageous in that it can provide a more uniform light emission from the window element. In addition, the window element according to the second aspect of the present invention is very little sensitive to external influences as it is protected by a glass pane and no light guide is used. In addition, as will be further explained in the description, the refracting structures may determine the desired angular light distribution of the light emitted from the window element.

In the following, embodiments relating particularly to the window element according to the first aspect of the present invention are described.

According to an embodiment, the window element may comprise an additional glass pane arranged at the side of the light guide opposite to the side at which the scattering structures are arranged, and a protective layer is sandwiched between the additional glass pane and the light guide. Such an embodiment is advantageous in that both sides of the light guide are protected since the light guide is enclosed (or encased) between two protective glass panes. Thus, the requirements on fire safety, maintenance and durability are fulfilled. In particular, fire hazard is greatly reduced if the light guide is enclosed between two glass panes.

The protective layer may be a layer of inert gas. The space between the surface of the light guide (opposite to the surface at which the scattering structures are arranged) and the additional glass pane may be filled with an inert gas such as, e.g., Nitrogen or Argon gas.

Alternatively, according to another embodiment, the protective layer may be a layer of additional scattering structures for coupling light out of the light guide, which is advantageous in that a window element capable of emitting light from both sides (or faces), i.e. a window element for double side emission, is achieved. The additional scattering structures are also sandwiched between the light guide and the additional glass pane such that spacing areas, at which optical contact between the light guide and the additional glass pane is prevented, are formed between the additional scattering structures. The scattering structures arranged at both sides of the light guide act as spacers for preventing optical contact between the light guide and the glass panes. Any undesired leakage of light out of the light guide into the glass panes is thereby prevented.

Alternatively, according to yet another embodiment, the protective layer may be made of a material having a refractive index lower than that of the material constituting the light guide. This embodiment is advantageous in that unwanted light leakage from the light guide to the additional glass pane is prevented. The layer of low refractive index (at least in comparison to that of the material constituting the light guide) is also advantageous in that it acts as an intermediate transparent layer enabling fixation of the light guide to the additional glass pane while avoiding light leakage to the additional glass pane.

According to another embodiment, the window element may comprise an anti-scratch coating arranged at the side of the light guide opposite to the side at which the scattering structures are arranged (i.e. arranged at the side without scattering structures).

According to an embodiment, the scattering structures may comprise luminescence material for altering the wavelength of the light coupled out of the light guide (and thereby altering the light emitted from the window element), which is advantageous in that a more light-efficient window element is achieved. This embodiment is also advantageous in that the uniformity of the light, and in particular the uniformity of the color of the light, emitted by the light guide is further improved.

In the following, embodiments relating particularly to the window element according to the second aspect of the present invention are described.

According to an embodiment, the light of the light source may be collimated and the light source may be arranged such that light emitted from the light source impinges the refracting structures at an angle of incidence which is larger than the angle of incidence of the light entering the glass pane after refraction at the refracting structures.

Further, the refracting structures may be micro-prisms, gratings or holographic structures.

Further, the window element may comprise an additional glass pane for enclosing the refracting structures, which is advantageous in that the refracting structures are protected against the surrounding environment.

In the following, embodiments relating to a window element according to any one of the first and second aspects of the present invention are described.

According to an embodiment, the scattering structures or the refracting structures are arranged in a pattern providing an image (e.g., a logo, a text or a sign) at the surface of the window element when the light source is powered on. In particular, the distribution of the scattering or refracting structures may be locally altered in specific areas to form a (positive or negative) image that becomes visible when the window element is in the on-state, i.e. when the light source is powered on. Such an image may be achieved by locally increasing or decreasing the amount (or density) of scattering or refracting structures, i.e. by locally increasing or decreasing the amount of light that is extracted from the light guide by the scattering structures or from the window element by the refracting structures, respectively.

According to a further embodiment, the window element may also comprise a filtering means (or a filter) arranged at regions of the glass pane at which transparency of the window element is affected by the pattern such that the level of transparency is more uniform over the entire area of the window element. Indeed, locally altering the distribution and/or density of the scattering or refracting structures over the surface of the window element may cause the image to be visible (due to a locally higher or lower transparency) even in the off-state, i.e. when the light source is turned off. The use of a filtering means (e.g. in the form of a foil) applied to the surface of the glass pane in regions affected by a change in transparency due to the pattern provides an improved uniformity of the transparency of the window element over its entire surface in the off-state. In other words, the image is made almost invisible for an observer when the emissive window is in the off-state.

According to an embodiment, the window element may comprise a motion sensor for detecting the distance of a person to the window element. Alternatively, the motion sensor may detect the speed of a person approaching the window element. The light source may then be powered on if the detected distance or the detected speed is below or above, respectively, a predetermined threshold. This embodiment is particularly advantageous in that collision of a person with the window element may be prevented.

According to an embodiment, the distribution, size and/or shape of the scattering or refracting structures may be selected to determine the angular distribution of the light emitted from the window element, which is advantageous in that the window element may be designed to emit light in a specific direction, not necessarily perpendicular to the surface of the window element.

Further, the window element of the present invention may be lit by means of at least two light sources arranged at two different edges, respectively, of the window element (or light guide). In particular, light may be emitted in the window element from at least two light emitting diodes emitting at different wavelengths (or colors). Such embodiments are advantageous in that gradients in color and intensity across the window element may be achieved.

The window element of the present invention may be arranged in a window frame or a door frame.

It is noted that the invention relates to all possible combinations of features recited in the claims.

### BRIEF DESCRIPTION OF THE DRAWINGS

This and other aspects of the present invention will now be described in more detail, with reference to the appended drawings showing various exemplifying embodiments of the invention.

FIG. 1 is a schematic view of a window element according to an exemplifying embodiment of the present invention;

FIG. 2 is a schematic view of a window element according to another exemplifying embodiment of the present invention;

FIG. 3 is a schematic view of a window element according to another exemplifying embodiment of the present invention;

FIG. 4a is a schematic view of a window element according to another exemplifying embodiment of the present invention;

FIG. 4b is a schematic view of a window element according to another exemplifying embodiment of the present invention;

FIG. 5 is a schematic view of a window element according to another exemplifying embodiment of the present invention;

FIG. 6 is a schematic view of a window element according to another exemplifying embodiment of the present invention;

FIG. 7 is a schematic view of a window element according to another exemplifying embodiment of the present invention;

FIG. 8 is a schematic view of a door comprising a window element according to an exemplifying embodiment of the present invention; and

FIG. 9 is a schematic view of the door shown in FIG. 8 when the window element is in its on-state.

### DETAILED DESCRIPTION OF THE EMBODIMENTS

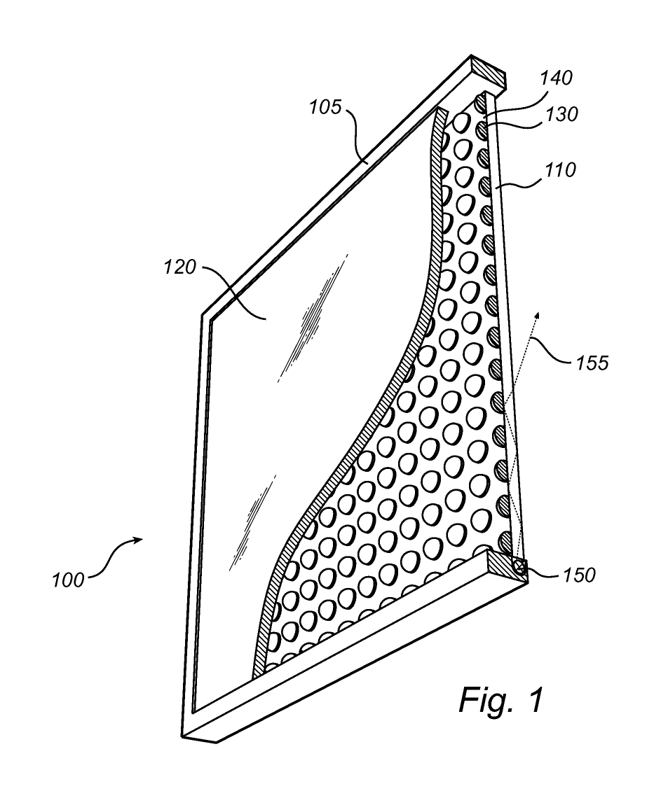

With reference to FIG. 1, a first embodiment of the present invention is described.

FIG. 1 shows a window element 100 comprising a light guide 110, a glass pane 120 and scattering structures 130. The light guide 110 is configured to guide light emitted from at least one light source 150 by total internal reflection. The light is guided within the body of the light guide 110 itself. The scattering structures (or out-coupling structures) 130 are arranged at a surface of the light guide 110 for coupling the light travelling within the light guide out of the light guide. The scattering structures 130 are sandwiched between the light guide 110 and the glass pane 120 such that spacing areas 140, at which optical contact between the light guide 110 and the glass pane 120 is prevented, are formed between the scattering structures 130.

The scattering structures 130 themselves act as spacers (or a spacing layer) between the light guide 110 and the glass pane 120, thereby preventing optical contact between the light guide 110 and the glass pane 120 and, thus, preventing unwanted light leakage from the light guide 110 to the glass pane 120. In such a window element, the thickness of the scattering structures insures that the light guide 110 does not make any optical contact (or at least significantly reduces the number of optical contact points) with the glass pane 120.

The scattering structures 130 arranged on a surface of the light guide 110 have the following effect. Light (or photons), represented as a light ray 155 in FIG. 1, emitted from at least one light source 150 arranged at an edge of the light guide 110 travels into the light guide 110 via total internal reflection, which is a lossless process (assuming negligible absorption in the light guide), until the light ray 155 hits a scattering structure 130, i.e. an irregularity (or localized non-uniformity). The conditions for total internal reflection are met if the angle of incidence of the light ray at an inner surface of the light guide is larger than a so-called critical angle with respect to the normal of the surface. The critical angle can be calculated based on the refractive indexes of the material constituting the light guide 110 and the material of the medium in contact with the light guide. The light ray 155 hitting a scattering structure 130 is reflected and may be incident at the opposite inner surface of the light guide 110 at an angle of incidence for which the conditions of total internal reflection are no longer met (the angle of incidence is smaller than the critical angle as defined with respect to the normal of the surface). As a result, the light exits the light guide 110. Thus, the scattering structures 130 force the light to deviate its trajectory and couple (or extract) the light out of the light guide.

The scattering structures 130 may be applied on a surface of the light guide 110 in the form of, e.g., screen printed dots or a line pattern. For example, the scattering structures 130 may form a pattern of diffuse white paint dots screen printed onto the light guide 110.

The scattering structures may be local roughness made by sand-blasting, diffractive structures such as gratings, or dots of white paint applied by silk-screening. The latter method is preferred for generating light towards predominantly one side only of the light guide and having a more or less Lambertian distribution. If the dots of paint are thick enough, they will diffusely reflect almost all light. In other words, almost all light can be coupled out towards one face of the light guide.

The active part of the emissive window element 100 may be a sheet of a transparent polymer material, such as, e.g., PMMA or PVC, acting as the light guide 110 in which light is injected at one or more of its edges. The light guide 110 may be defined as a sheet or pane with two faces (or sides) of rather large area in comparison to the area of its edges (or lateral sides) corresponding to the thickness of the light guide sheet. The light guide may be a relatively thin sheet of polymer and may for instance have a rectangular or hexagonal shape (in fact, any type of shape). A side of the polymer light guide is protected from external influences by at least one glass pane 120, which preferably is transparent. The glass sheet (or glass pane) 120 may be made of standard float glass. In view of the generally large temperature expansion coefficient and hygroscopic nature of polymer materials, protection of the light guide 110 by means of a glass pane 120 is advantageous since deformation and warping of the light guide 110 may otherwise occur when exposed to, e.g., temperature and moisture fluctuations. Further, polymer materials generally have a rather low fire resistance, which make them a fire hazard, in particular when large areas are freely exposed. For example, PMMA has a temperature expansion coefficient equal to about 5-10×10⁻⁵ K and a self ignition temperature of about 400 to 465° C.

The scattering structures 130 (i.e. the out-coupling pattern) may be firmly secured against the protective glass pane 120 by creating a vacuum between the protective glass pane 120 and the light guide 110 or by applying glue between the scattering structures 130 (e.g. dots) and the glass pane 120, which is advantageous in that deformations of the light guide may be minimized and the rigidity and robustness of the total structure of the window element 100 may be improved. Alternatively, the scattering structures 130 may themselves be made of a glue-like material, i.e. an adhesive material, thereby eliminating the need of applying glue as a separate step when assembling the window element 100. The scattering structures 130 are then firmly secured against the glass pane 120 by simply pressing them against each other.

It is noted that the above described window element 100 and the window element described in the following are transparent window elements when in the off-state (i.e. when the light source is turned off) since the coverage area of the scattering dots corresponds only to a fraction of the total area of a face of the light guide, thereby allowing a lasting clear and undistorted view through the window element. The out-coupling structures typically do not cover more than 10% of the surface, thereby providing a window element which appears transparent in the off-state and is therefore virtually invisible, especially when observed at a sufficiently large distance (e.g. 1 meter or more).

The coverage of the scattering structures is preferably such that the direct transparency of the light-guide is as high as possible, i.e. that a relatively high fraction of the light rays is transmitted while the direction of the light rays is not changed. Generally, the thinner the light-guide, the smaller the coverage. Using, for example, thin light-guides of about 1 to 3 mm in thickness, the direct transparency of the emissive window can be in the order of about 70% or more.

Further, the out-coupling structures 130 may preferably be not visible. As the angular resolution of the human eye is approximately 1/60°, it can be deduced that, when viewing such a window element from a 1 meter distance, the size of the out-coupling structure is preferably less than about 0.29 mm.

An example of light guide for achieving a transparent emissive window according to the present invention could have a thickness of less or equal to 3 mm, a coverage area by the out-coupling structures (in case of discrete structures) of less than 30%, and a feature size of the individual out-coupling structures of less than 0.6 mm (i.e. invisible from a distance of 2 m onwards).

Further, in order to obtain a somewhat homogeneous out-coupling of the light over the entire surface of the light guide, the pattern of the scattering structures close to the edges where the light source(s) is (are) located will typically be less dense than the pattern farther away from the light source(s). Alternatively, or in addition, the scattering structures close to the edges where the light source(s) is (are) located will typically be smaller than the scattering structures located farther away from the light source(s).

Although only one light source is used in the embodiment described with reference to FIG. 1, it will be appreciated that more than one light source may be used for injected light at one or more of the edges of the light guide 110.

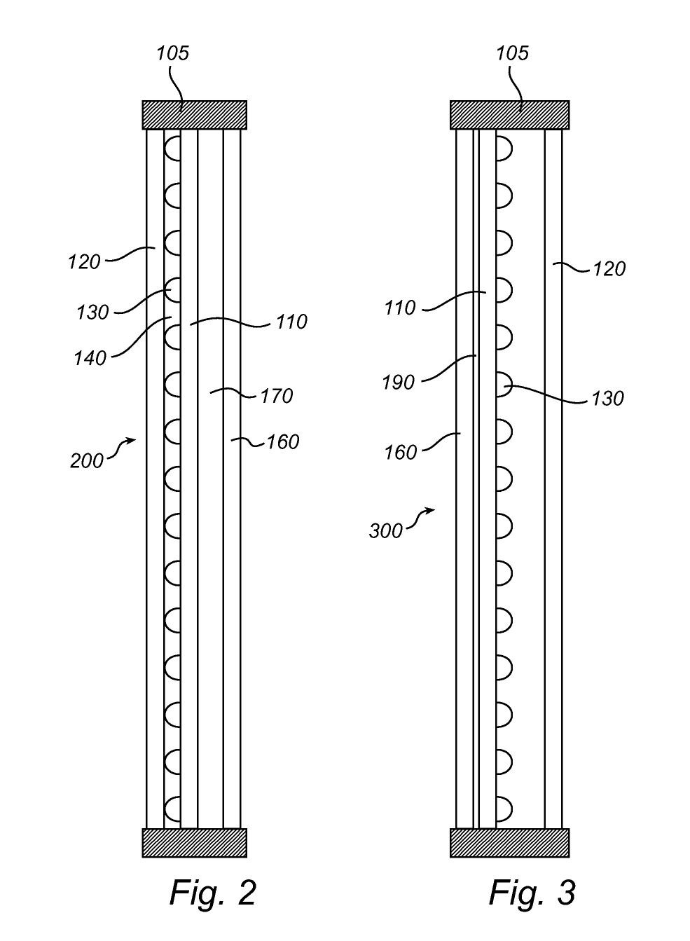

With reference to FIGS. 2-4, further embodiments of the present invention are described.

In these embodiments, the window element may comprise an additional glass pane 160 arranged at the side of the light guide 110 opposite to the side at which the scattering structures 130 are arranged, and a protective layer is sandwiched between the additional glass pane 160 and the light guide 110. In these embodiments, the light guide 110 is enclosed between two glass panes 120 and 160 such that both sides of the light guide 110 are protected from external influences while at the same time a protective layer is arranged between the light guide 110 and the additional glass pane 160 in order to prevent optical contact between them, i.e. some space or distance is created between the light guide and the additional glass pane. In other words, the opposite side of the light guide (i.e. the side without the scattering structures 130) is also protected by a glass pane while leakage from the light guide to the additional glass pane is prevented. Such embodiments are particularly advantageous with respect to the requirements on fire safety, maintenance and durability.

FIG. 2 shows a window element 200 comprising a light guide 110, two glass panes 120 and 160, scattering structures 130 and a layer 170 of inert gas. The window element 200 is identical to the window element 100 described with reference to FIG. 1 except that it comprises an additional glass pane 160 arranged at the side of the light guide 110 opposite to the side at which the scattering structures 130 are arranged, and a layer 170 of inert gas sandwiched between the additional glass pane 160 and the light guide 110. The layer of inert gas corresponds to the space between the surface of the light guide 110 without any scattering structures 130 and the additional glass pane 160. The inert gas may, e.g., be Nitrogen or Argon gas.

FIG. 3 shows a window element 300 comprising a light guide 110, two glass panes 120 and 160, scattering structures 130 and a layer 190 of a material having a refractive index lower than that of the material constituting the light guide 110. The window element 300 is identical to the window element 100 described with reference to FIG. 1 except that it comprises an additional glass pane 160 arranged at the side of the light guide 110 opposite to the side at which the scattering structures 130 are arranged, and a layer of a material having a refractive index lower than that of the material constituting the light guide 110. The layer 190 of low refractive index is sandwiched between the additional glass pane 160 and the light guide 110. The layer 190 of low refractive index acts as a cladding material used to enhance the wave-guiding efficiency of the light guide 110, thereby preventing any unwanted light leakage into the additional glass pane 160. Further, the layer 190 of low refractive index acts as an intermediate transparent layer enabling fixation of the light guide 110 to the additional glass pane 160. The layer 190 of low refractive index may be continuous or discontinuous such as, for example, a dot pattern.

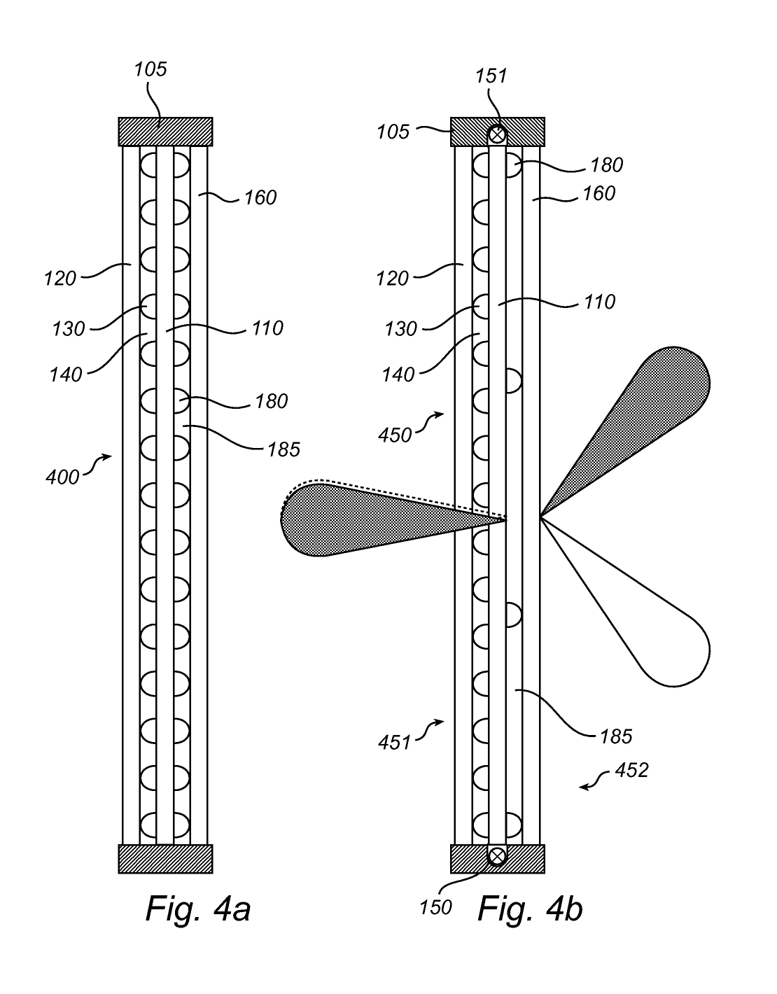

FIG. 4a shows a window element 400 comprising a light guide 110, two glass panes 120 and 160 and scattering structures 130 and 180. The window element 400 is identical to the window element 100 described with reference to FIG. 1 except that it comprises an additional glass pane 160 arranged at the side of the light guide 110 opposite to the side at which the scattering structures 130 are arranged, and additional scattering structures 180 sandwiched between the additional glass pane 160 and the light guide 110. The additional scattering structures 180 are configured to couple light out of the light guide 110, thereby providing a window element capable of emitting light from both faces, i.e. a window element adapted for double side emission. In the present embodiment, scattering structures are arranged at both sides of the light guide. The additional scattering structures 180 are also sandwiched between the light guide 110 and the additional glass pane 160 such that spacing areas 185, at which optical contact between the light guide 110 and the additional glass pane 160 is prevented, are formed between the additional scattering structures 180.

According to an embodiment, the pattern of the scattering structures 130 arranged at one side of the light guide 110 may be different than the pattern of the additional scattering structures 180 arranged at the opposite side of the light guide 110 in order to control the light distribution and/or the intensity of the light emitted from each side of the light guide 110 (i.e. from each face of the window element 400). The light distribution and intensity of the light emitted at a face of the window element may for instance be determined by the distribution and density of the scattering structures arranged at the light guide for the particular face but also by the material, color and/or transparency level of the material constituting the scattering structures. For example, for achieving a side (or face) of a window element emitting a large amount of light in comparison to its opposite side, smaller or fewer scattering structures, or alternatively scattering structures made of a more transparent material, may be arranged at the side of the light guide from which a large amount of light is to be emitted. In such a window element, light emitted from at least one light source at one edge of the light guide travels into the light guide via total internal reflection until it hits a scattering structure. On the one hand, a light ray (or photons) hitting a less transparent or non-transparent scattering structure (e.g. a non-transparent white paint dot) is reflected and may be incident at the opposite surface of the light guide at an angle of incidence for which the conditions of total internal reflection are not met. As a result, the light ray exits the light guide. On the other hand, light hitting one of the more transparent scattering structures may be partly diffusely transmitted and, thus, directly extracted from the light guide. Another fraction of the light hitting one of the more transparent scattering structures may be diffusely reflected back into the light guide in which it may again hit a diffusely reflective scattering structure at the opposite surface.

It is to be noted that, by tuning the thickness of the dots, the ratio of light sent to the front and to the back of the window element, i.e. the ratio of light emitted from the two faces of the window element, can be tuned to some extent.

FIG. 4b shows an example of such a window element. The window element 450 is identical to the window element described with reference to FIG. 4a except that the scattering structures 130 arranged at a first side of the light guide 110 corresponding to a first face 451 of the window element 450 are more dense than the additional scattering structures 180 arranged at the opposite side of the light guide 110 corresponding to the second face 452 (which is opposite to the first face) of the window element 450. As a result, the angular distribution of the light emitted from the first face 451 of the window element 450 is different than the angular distribution of the light emitted from the opposite face 452 of the window element 450, as illustrated by the lobes shown in FIG. 4b. If used as a window for a building, the out-coupling structures of the window element may be designed such that the angular profile for the light directed inwards differs from that of the light directed outwards.

In addition, the use of different patterns on each side of the light guide may provide a window element emitting different amount of light at each side of the window element. For example, the window element may be designed such that a pre-determined ratio of light emitted towards the front and towards the back of the window is achieved (for example, 90% of the light directed inwards and 10% directed outwards).

Such a window element may for instance be used as a window for dividing a space into two separate spaces (e.g. office spaces) such that, for example, when looking at the window from one side it looks like a privacy window (the light emitted masks the scene behind the window) and, when looking at the window from the other side, the light distribution is such that it illuminates the room or creates an atmosphere.

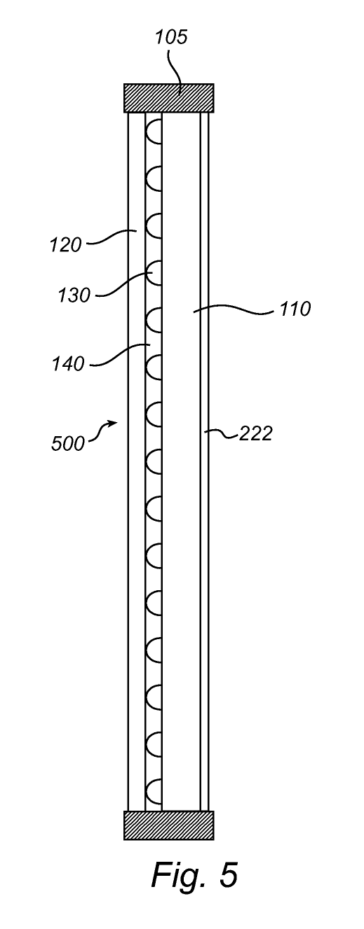

With reference to FIG. 5, another embodiment of the present invention is described.

FIG. 5 shows a window element 500 comprising a light guide 110, a glass pane 120, scattering structures 130 and an anti-scratch layer or anti-scratch coating 222. The window element 500 is identical to the window element 100 described with reference to FIG. 1 except that it comprises an anti-scratch coating 222 arranged at the side of the light guide opposite to the side at which the scattering structures are arranged (i.e. at the side without scattering structures). In this embodiment, both sides or surfaces of the light guide 110 are protected, one surface being protected by means of the glass pane 120 and the opposite surface being protected by means of the anti-scratch coating 222. This embodiment is advantageous in that the assembly of the window element is facilitated. In addition, replacing the additional glass pane by an anti-scratch layer lowers the total weight of the window element. With this embodiment, the emissive window element can more easily be added to existing building structures, e.g. replacing an already existing window by the emissive window element 500 or adding the emissive window element 500 to an already existing window.

According to an embodiment, the scattering structures 130 and 180 of the window elements as described with reference to any one of FIGS. 1-5 may comprise luminescence material for altering the wavelength of the light scattered from (or coupled out of) the light guide. In particular, the scattering structures 130 and 180 may comprise phosphors. For example, the light emitted from the window element may be tuned by converting part of the blue light travelling within the light guide 110 into yellow light. As a result, the remainder of the blue light together with the yellow light may provide an impression of white light emission. This embodiment is advantageous in that a more light-efficient window element is achieved and that the uniformity of the color of the light emitted by the window element is improved.

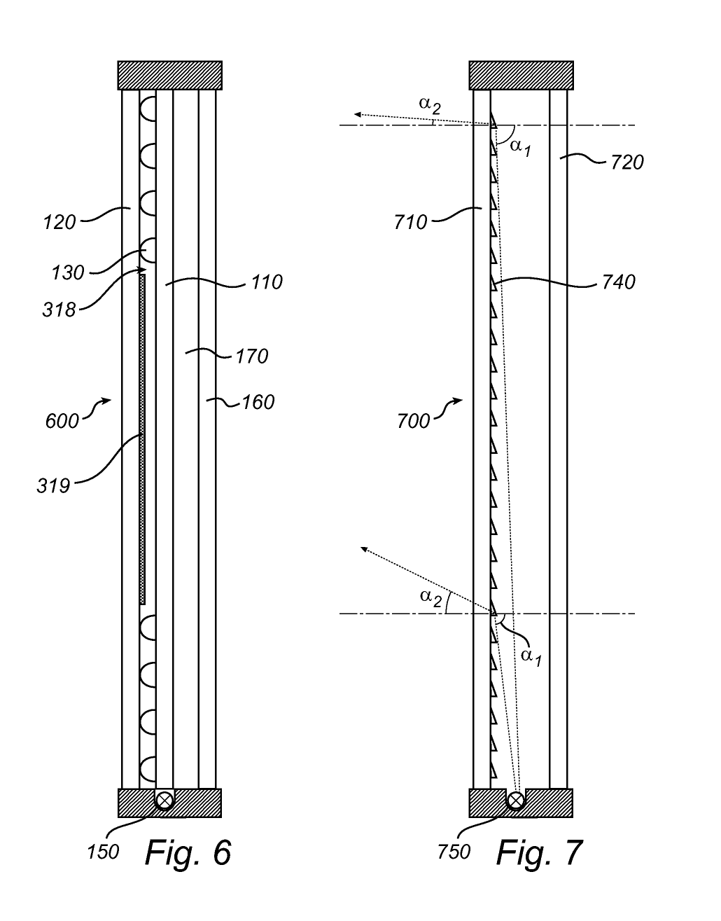

With reference to FIG. 6, another embodiment of the present invention is described.

FIG. 6 shows a window element 600 which is identical to the window element 200 described with reference to FIG. 2 except that the scattering structures 130 are arranged in a pattern providing an image 318 at the surface of the window element 600, which image is visible when the light source is powered on. In particular, the distribution of the scattering structures 130 may be locally altered in specific areas to form a (positive or negative) image of a logo or a text that becomes visible when the window is in the on-state, i.e. when the light source is powered on. Such an image may be achieved by locally increasing or decreasing the amount of scattering structures 130, i.e. by locally increasing or decreasing the amount of light that is extracted from the light guide or by the refracting structures. However, altering the distribution of the scattering structures 130 may cause the pattern (i.e. the image) to be visible even in the off-state, i.e. when the light source is turned off, due to a locally higher or lower transparency. Thus, the window element 600 may also comprise a filtering means or filter 319 arranged at regions of the glass pane at which transparency of the window element is affected by the pattern such that the level of transparency is more uniform over the entire area of the window element. The use of a filtering means (e.g. in the form of a foil) 319 applied to the surface of the glass pane 120 in regions affected by a change in transparency due to the pattern provides an improved uniformity of the transparency of the window element over its entire surface. As a result, the image is made almost invisible for an observer when the emissive window is in the off-state.

With reference to FIG. 7, another embodiment of the present invention is described.

FIG. 7 shows a window element 700 comprising at least one light source 750, a glass pane 710 and refracting structures 740 arranged at a surface of the glass pane 710 such that light emitted from the light source 750 is refracted by the refracting structures 740 towards the glass pane 710 and directed out of the window element 700. The refracting structures 740 have the property of changing the direction of the incident light to another direction as the light (or wave) passes from one medium to another. The angle of refraction is determined by the refractive indexes of the mediums, i.e. the refractive index of the material constituting the refractive structures 750 and the refractive index of the medium in which light travels from the light source 750 to the refracting structures 740 (e.g. air), the angle of incidence of the light at the refracting structure 740 and the shape of the refracting structures.

In particular, the light of the light source 750 may be collimated and the light source may be arranged such that light emitted from the light source 750 impinges the refracting structures 740 at an angle of incidence which is larger than the angle of incidence of the light entering the glass pane after refraction at the refracting structures. As a result, the light emitted from the window element 700 is almost perpendicular to the surface of the window element. It will be appreciated that the light source may then be arranged differently such that the light emitted from the window element 700 is not perpendicular to the surface of the window element.

The refracting structures may for instance be micro-prisms, gratings or holographic structures.

Further, the window element 700 may comprise an additional glass pane 720 for enclosing the refracting structures 750, which is advantageous in that the refracting structures may be protected against any external influences. The resulting angle of refraction is then also determined by the refractive index of the material (or gas) constituting the space defined between the two glass panes 710 and 720.

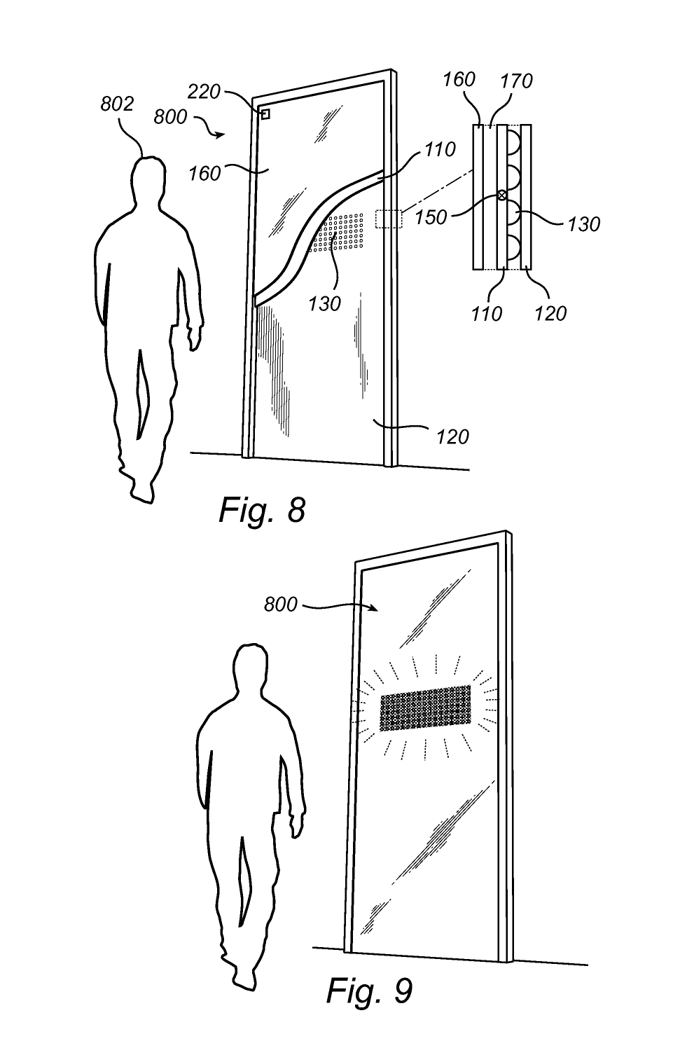

With reference to FIG. 8, another embodiment of the present invention is described.

FIG. 8 shows a window element 800 which is identical to the window element 200 described with reference to FIG. 2 except that it further comprises a motion sensor 220. However, the window element 800 may be identical to any one of the window elements 300, 400, 450, 500, 600 and 700 described with reference to FIGS. 3-7, respectively, except that it further comprises a motion sensor 220.

Generally, people running or going towards a window or door comprising a clear and transparent window element may have difficulty in seeing the presence of the window or the door. Thus, there is a risk of collision between the person and the window element, thereby resulting in injuries. The present embodiment is advantageous in that collision may be prevented by detection of the person approaching the window and the possibility of warning the person by lighting up the window element. Further, as compared to traditional solutions wherein a non-transparent foil or sticker is applied on the window or a diffuse pattern is etched into the glass part of the window, i.e. traditional solutions wherein the warning sign is permanently visible, the solution proposed here provides a window element which is transparent when it is turned off, i.e. when there is no need of warning anyone. If no one is in the immediate vicinity of the window element (or in danger), the window element appears almost completely transparent.

The sensor 220 may be arranged or integrated at the window element 800 itself, into the frame of the window element, at a door handle of a door comprising the window element or even arranged separately in the ceiling, floor or wall close to the location of the window element for which prevention is desired. The motion or presence sensor 220 could for example be an infra-red based sensor, a radar based sensor or an ultrasound based sensor.

If a person 802 is approaching a door or window comprising a transparent window element 800 such as those described in the above (but the person is still some distance away), the motion sensor 220 detects the presence of the person 802 and the light source 150 of the window element 800 is slowly switch on and gradually increase its intensity as the person comes closer, as further illustrated in FIG. 9. The approaching person will then notice that light is emitted from the window element and thereby be aware that there indeed is a window or door in his/her path.

Alternatively, the sensor 220 may be adapted to determine the speed at which the person 802 is approaching to the window element 800. If the person is approaching quickly (e.g. someone is running and is in danger of violently crashing into a closed door comprising a transparent window element), the light source(s) can be activated such that the window element is switched on to full intensity immediately. Alternatively, the window element may be adapted to quickly switch on and off the light source(s) in a repetitive manner in order to more efficiently attract the attention of the approaching person (with a blinking sign) and prevent a collision. Another possibility for more efficiently attracting the attention of the person may be to rapidly change the color of the light emitted from the window element 802. This may be implemented by replacing the light source by a plurality of light emitting diodes (e.g. RGB LED's) emitting at different colors.

It will be appreciated that the window element 802 may then comprise a control unit (not shown in the figures) for receiving a signal input from the motion sensor 802 and for controlling (possibly individually) the light source(s) arranged at the lateral sides of the window element 802 in accordance with the received input signal.

Referring to FIGS. 8 and 9, only a part of the entire surface of the window element 802 is configured to emit light, i.e. scattering structures are only arranged on part of the face of the light guide, which may be sufficient for warning the person approaching the window or the door. However, it will be appreciated that the scattering structures may also be spread over the entire surface of the light guide such that the entire surface of the window element is emissive when the light source is powered on (on-state).

Depending on the size and required luminous output of the emissive window element, the electrical power for the light sources (e.g. LEDs) may be provided by a wired connection to the mains supply (via an electrical transformer to provide the appropriate current/voltage) or a battery that can be incorporated in e.g. the window frame. Alternatively, the electrical power may be supplied by solar cells that can be attached onto the window frame or the glass pane itself. The solar cells may be a rather narrow strip of (semi-transparent) thin film applied on the window or door frame or on the edge of the window element, which is advantageous in that it is rather unobtrusive and therefore aesthetically pleasing for an observer.

It will be appreciated that, according to another embodiment, the window element may only comprise a glass pane which is lit from its edge(s) and itself functions as a light guide. However, due to the high absorption (i.e. low transmission) of standard float glass, the light that is coupled into the pane from the edge(s) will not travel very far before being absorbed. The relatively short distance along which the light travels might nevertheless be sufficient for lighting up the edge(s) of the window pane and therefore alert a person of the presence of a window element for avoiding a collision. Scattering structures may be applied on the glass pane near the edges for facilitating the out-coupling of the light.

The window element described with reference to any one of FIGS. 1-8 may be mounted on a window frame (or door frame), denoted 105 in the figures, thereby providing windows which, on the one hand, enable entrance of daylight into a room thanks to the transparency of the window in the off-state and, on the other hand, provide functional lighting (or create an atmosphere) during dark periods when the window is in the on-state. If needed, for instance during grey and cloudy days with low levels of daylight in wintertime, the window may be used to enhance the light entering a room by, for example, adjusting the color temperature of the daylight entering the space by turning on the light source. Such windows may also be used as a switchable privacy window or a window dividing living spaces (in particular when a window with double side emission is used).

According to an embodiment, such as that shown in FIG. 4b, several light sources may be arranged at the edges of the light guide. In particular, the light sources may be light emitting diodes emitting at different wavelengths such that several colors and mix of colors may be achieved. Separate (or individual) control of the light sources may enable the creation of particular atmosphere on the window element. Using many light-sources enable emission of light at different colors and gradients in color and intensity across the light-guide, which can be used to create an atmosphere resembling for example a sunset or clouds passing by.

The light sources may be located in diamond-shaped recessions (holes) in the light guide. The diamond shape ensures that the light of a certain light source is quickly mixed with that of a neighboring light source (that may emit at a different color to make a color-adaptable emissive window). It also ensures a reduced chance that light emitted by a light source is absorbed by another light source. The edges of the light-guide may be equipped with mirrors to reduce loss of light.

Further, pre-collimation of the light before entering the light-guide may be advantageous since it facilitates the realization of a predetermined angular distribution of the light coupled out of the light-guide (especially when a narrow distribution is required).

It will be appreciated that the scattering or refracting structures may be arranged such that the light leaves the window at a direction which is substantially not perpendicular to the window. As a result, the window may be adapted to illuminate the side walls, the ceiling and/or the floor of the room in which it is installed, while the ability to see through the window remains intact.

The person skilled in the art realizes that the present invention by no means is limited to the preferred embodiments described above. On the contrary, many modifications and variations are possible within the scope of the appended claims. For example, although the example of forming an image or logo on the window element when the light source is powered on has been described with reference to FIG. 6 for a window element according to the first aspect of the present invention, a window element according to the second aspect of the present invention may also be adapted for forming such an image or logo. Further, although a window element for double side emission has only been described with reference to FIG. 4 for a window element according to the first aspect of the present invention, a window element according to the second aspect of the present invention may also be adapted for achieving a window element for double side emission. In that case, the window element comprises two protective glass panes with refracting structures arranged at each of them and the light sources are arranged such that light is emitted in direction to the refracting structures. The refractive structures (in particular, their density, material, size and shape) may be selected such that the respective angular distribution and/or the intensity of the light emitted from the two faces of the window element are identical or different, depending on the application. Further, the use of phosphors at or in the refracting structures may also be suitable for altering the wavelength of the light emitted from a window element according to the second aspect of the present invention.

1. A window element comprising:
a light guide for guiding light emitted from at least one light source by total internal reflection,
a glass pane arranged in proximity to the light guide, and
scattering structures for coupling the light out of the light guide, wherein the scattering structures are sandwiched between the light guide and the glass pane such that spacing areas, at which optical contact between the light guide and the glass pane is prevented, are formed between the scattering structures.

2. A window element according to claim 1, further comprising an additional glass pane arranged at the side of the light guide opposite to the side at which the scattering structures are arranged, wherein one of a group comprising a layer of inert gas, a layer of additional scattering structures for coupling light out of the light guide and a layer of a material having a refractive index lower than that of the material constituting said light guide, is sandwiched between said additional glass pane and said light guide.

3. A window element according to claim 1, further comprising an anti-scratch coating arranged at the side of the light guide opposite to the side at which the scattering structures are arranged.

4. A window element according to claim 1, wherein said scattering structures comprise luminescence material for altering the wavelength of the light coupled out of the light guide.

5. A window element comprising:
at least one light source,
a glass pane, and
refracting structures arranged at a surface of said glass pane such that light emitted from the light source is refracted by said refracting structures towards said glass pane and directed out of the window element.

6. A window element according to claim 5, wherein the light of said light source is collimated and the light source is arranged such that light from the light source impinges said refracting structures at an angle of incidence (α₁) which is larger than the angle of incidence (α₂) of the light entering the glass pane after refraction at said refracting structures.

7. A window element according to claim 5, wherein said refracting structures are one of a group of micro-prisms, gratings and holographic structures.

8. A window element according to claim 5, further comprising an additional glass pane for enclosing the refracting structures.

9. A window element according to claim 5, wherein the refracting structures are arranged in a pattern providing an image at the surface of the window element when said at least one light source is in its on-state.

10. A window element according to claim 9, further comprising a filtering means arranged at regions of said glass pane at which transparency of the window is affected by the pattern such that the level of transparency is more uniform over the entire area of the window element.

11. A window element according to claim 5, further comprising a motion sensor for detecting at least one of the distance of a person to the window element and the speed of a person approaching the window element such that the light source is powered on if the detected distance or the detected speed is below or above, respectively, a predetermined threshold.

12. A window element according to claim 5, wherein the distribution and size of said refracting structures determine the angular distribution of the light emitted from the window element.

13. A window element according to claim 5, wherein the window element is lit by means of at least two light sources arranged at least two different edges, respectively, of the window element.

14. A window element according to claim 13, wherein light is emitted in the window element from at least two light emitting diodes emitting light at different wavelengths.

15. (canceled)
